(19) United States
(12) Patent Application Publication
(10) Pub. No.: US 2003/0151663 A1
(43) Pub. Date: Aug. 14, 2003

(54) Video storage and delay device for use with an in-car video system

(75) Inventors: Leo Lorenzetti, Hardyston, NJ (US); Louis W. Blanco, Boonton, NJ (US)

Correspondence Address: MAYER, FORTKORT & WILLIAMS, PC, 251 NORTH AVENUE WEST, 2ND FLOOR, WESTFIELD, NJ, 07090, US

(73) Assignee: Mobile-Vision, Inc., Boonton, NJ

(21) Appl. No.: 10/055,629

(22) Filed: Jan. 23, 2002

(51) Int. Cl. H04N 7/18; H04N 9/47

(52) U.S. Cl. 348/148; 340/937

(57) ABSTRACT

An in-car video apparatus and method is provided where a real time continuous video supplied by a vehicle-mounted camera and an audio microphone is processed for storage in a memory in a time-sequential manner for a pre-set time interval to create a time-delayed video stream. Upon activation of the in-car video system by a law enforcement officer (which occurs at an arbitrary reference time), a vehicle-mounted recording device records the time-delayed video stream to create a video recording of the events captured by the video camera. Because the time-delayed video stream is recorded rather than the real time video stream, the start time of the video recording precedes the reference time by the pre-set time interval. The invention provides an ability to create a complete record of a police-citizen encounter, including the initial incident that prompted the officer's subsequent activation of the in-car video system.

### BACKGROUND OF THE INVENTION

This invention is related generally to surveillance systems, and more particularly to a video storage and delay device for use with an in-car video system.

Vehicle-mounted surveillance systems, including in-car video systems, are seeing increased use in the security industry and law enforcement community as an effective means to provide an indisputable video and audio record of encounters involving officers and citizens. In these systems, a video camera is typically mounted on the police car's dashboard or windshield and is generally arranged to have a field of view of the area to the immediate front of the car. The field of view approximately corresponds to what an officer would see when seated in the car's front seat.

The video camera is operably coupled to a recording device, such as a video cassette recorder (“VCR”), mounted in the police car, often in the trunk. Generally, video recordings are not made continuously during routine police patrol. Instead, to reduce videotape costs and avoid excessive wear and tear on the recording equipment (particularly, the recording heads), recordings are made only during incidents of interest, such as traffic stops and pursuits, for which an evidentiary record is desired. A videotape recording may be started manually by the officer, or in some systems, the videotaping is started automatically when, for example, the officer activates the police car's emergency systems (such as overhead lights and/or sirens), or when a vehicle speed-measuring radar unit is operated.

In-car video systems generally employ a wireless microphone carried on the person of a law enforcement officer to record an audio soundtrack that accompanies the visual scene captured on videotape. The audio soundtrack is an extremely valuable complement to the recorded video because it acts as a transcript of what was said, by whom and when. In some systems, additional wired microphones may be deployed in other locations within the car, such as the rear seat passenger area, to record sounds and conversations emanating from those locations.

In-car video systems serve to enhance prosecution of traffic, DWI/DUI and controlled dangerous substances offenses (to name just a few) by contributing detailed graphical and auditory evidence in a time-sequential manner that is inherently unbiased and objective. Such evidence is a valuable adjunct to eyewitness and officer testimony. Videotaped evidence is also increasingly used to substantiate the legal basis, referred to as “probable cause,” for a stop, arrest, search, or the issuance of a citation (i.e., ticket).

In addition, as with other quality-improvement initiatives where conduct is surveyed and recorded, in-car video system usage has been shown to assist in the maintenance of high professional standards among law enforcement personnel. Police-community relations have improved and citizen complaints of police misconduct have lessened in many jurisdictions where in-car video systems are used, often as a result of the inherently high-quality evidence provided by such systems. Videos taken with in-car video systems are also valuable training aids to law enforcement personnel.

Videotape evidence is protected (and the evidentiary chain of custody readily established) because the video cassette recorder and video recording medium (i.e., videotape) are typically “locked”, often both mechanically and electronically, within a tamperproof security enclosure in the car that is only accessible by law enforcement command personnel. In addition, the in-car systems are configured to prevent erasure or over-recording of a recorded encounter to ensure the integrity of the videotaped evidence. In-car video systems may superimpose time and date stamps on the recorded video image as a further enhancement to the evidentiary strength of the videotape.

Current in-car video systems perform very well in many applications. However, the fact that most systems are not videotaping continuously means that some evidence may miss being recorded before the officer has the chance to activate the video recorder. For example, a car driving through a stop light or weaving erratically through traffic may prompt the officer to hit the “record” button to manually begin a video recording, or activate the emergency lights to automatically start the recording in anticipation of effecting a car stop. Unfortunately, by the time the video recording starts, the initial incident (i.e., the disregarded traffic control device or erratic driving) that prompted the officer's attention has already occurred and can not be recorded. If the driver does not engage in additional unlawful behavior, then current in-car video systems will only capture a record of the vehicle pulling over and the officer's subsequent interaction with the suspect. However, the probable cause to support the car stop, and any subsequent traffic ticket, search or arrest may not necessarily be part of the videotaped record.

### SUMMARY OF THE INVENTION

An in-car video apparatus and method is provided where a real time (i.e., “live”) continuous video stream supplied by a vehicle-mounted camera is processed for storage in a memory in a time-sequential manner for a pre-set time interval to create a time-delayed video stream. Upon activation by a law enforcement officer (which occurs at an arbitrary reference time), a vehicle-mounted recording device records the time-delayed video stream to create a video recording of the events captured by the video camera. Because the time-delayed video stream is recorded rather than the real time video stream, the start time of the video recording precedes the reference time by the pre-set time interval. The invention thus provides an ability to record an event after it has already occurred.

In an exemplary embodiment of the invention, an in-car video camera sends a continuous analog real time video stream to a video delay and storage device. An audio microphone captures an analog audio soundtrack that accompanies the video images. The audio and video streams are received through an input interface at the video delay and storage device. An analog-to-digital converter digitizes the analog video and audio streams into a digital data stream that is then compressed by a digital encoder. A central processor in the video delay and storage device sequentially processes the compressed digital data stream for storage in a coupled memory. The compressed digital data is temporarily held in the memory for a pre-set time interval and is then sequentially output to a digital decoder that decompresses the digital data. A digital-to-analog converter converts the digital data into analog form. Analog video and audio streams that are time-delayed by the pre-set interval (compared with the real time video and audio streams) are output through an output interface of the video delay and storage device. The central processor controls the overall signal flow and processing throughout the video delay and storage device. Upon activation, a vehicle-mounted recording device, such as a VCR, records the time-delayed video stream from the video delay and storage device.

In other embodiments of the invention, a discrete (i.e., self-contained and requiring only external power and signal connections) video storage and delay device is provided with a pre-set time interval (i.e., the amount of time-delay) that is user-definable. In addition, either analog or digital signals may be accepted at a standard input interface of the video storage and delay device, and both digital and analog time-delayed output streams are provided. Two audio tracks—one for a wireless microphone and the other for a rear seat microphone—are also processed and output via a standard interface by an embodiment of the digital storage and delay device.

The invention provides many advantages. By buffering the real time video and audio streams to create the time-delayed video and audio stream, the officer has a period of time equal to the pre-set time interval to react to a witnessed event, such as a traffic infraction, and activate the video recorder. For example, if the time-delay is six seconds, then the officer is provided with up to six seconds in which to activate the video recorder and still be able to record the witnessed event on videotape. Accordingly, the invention provides a complete record of a police-citizen encounter, including the initial incident, event or behavior that captured the officer's attention in the first place. The odds that evidence supporting probable cause is contained in the videotaped record are thus greatly enhanced.

When the principles of the invention are embodied in the self-contained video storage and delay device, further advantages are realized. Once connected to the real time video and audio sources and external power, the video storage and delay device operates transparently without requiring any extra user intervention or attention. By using standard I/O interfaces, the inventive arrangement may be simply serially connected between the signal sources (i.e., video camera and microphone) and the video recorder using standard signal connections. Advantageously then, the video storage and delay device may be retrofitted to existing in-car video systems to thereby realize the benefits in the ability provided by the invention to record an event after it has occurred.

### BRIEF DESCRIPTION OF THE DRAWINGS

FIG. 1 is a simplified functional block diagram of an illustrative arrangement of the present invention and depicts an in-car video surveillance system including a windshield mounted camera and trunk-mounted video recorder, a wireless microphone, a rear seat microphone, a control head, a video monitor, and a video storage and delay device;

FIG. 2 depicts the sequential storage of a real time video stream used to create a time-delayed video stream, in accordance with the invention;

FIG. 3 depicts a group of timelines showing that the present invention provides an ability to create a permanent record of an event that begins prior to the activation of the in-car video recorder;

FIG. 4 shows a real time video stream, a time-delayed video stream and an exemplary video sequence, in accordance with the invention;

FIG. 5 is a simplified block diagram of a video storage and delay device, in accordance with the invention;

FIG. 6 is a simplified block diagram of a video storage and delay device having an optional user interface, in accordance with the invention; and

FIG. 7 is a pictorial representation of a user interface having user-accessible controls and a visual display.

### DETAILED DESCRIPTION

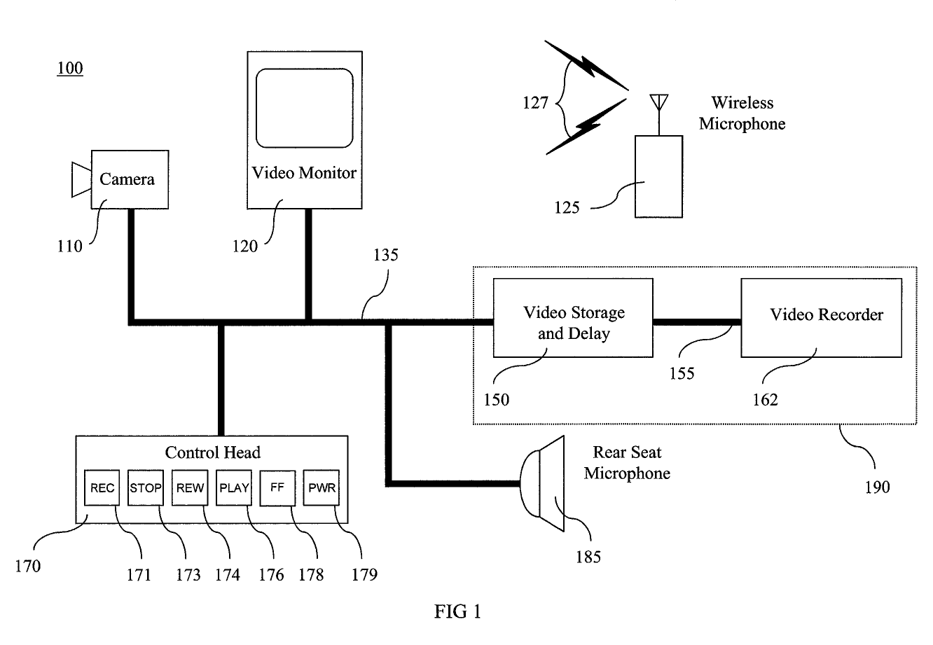

Referring now to FIG. 1, there is shown a simplified functional block diagram of an illustrative arrangement of the present invention. Shown is in-car video system 100 that includes a camera 110 that is typically mounted to look out through the windshield and/or rear window of the car. The in-car video system 100 further includes a rear seat microphone 185, video monitor 120, control head 170, and a video storage and delay device 150. Each of these components is coupled via a wiring bus 135, as shown in FIG. 1, that provides signal and power connections in a conventional manner.

A video recorder 162, for example a VCR, is coupled to the video storage and delay device 150 by wiring bus 155. Thus, in accordance with the invention, video storage and delay device 150 may be arranged to be connected serially between the signal sources (i.e., camera 110 and microphones 125 and 185) and video recorder 162, as shown in FIG. 1. Video storage and delay device 150 is typically embodied in a small enclosure that may be located in a convenient area of the vehicle including the passenger compartment (such as in glove box, under the dashboard or front seat, or in the electronic and emergency equipment console that is typically located in the center area of the vehicle by the front seats) or in the trunk.

In an alternative arrangement of the invention, the features and functions of video storage and delay device 150 may be directly incorporated (i.e., “built-in”) to other components of the in-car video system 100. For example, a video recorder and the video storage and delay device of the present invention may be combined into a single unit. Thus, in accordance with the invention, video storage and delay device 150 may be a discrete, self-contained device, or be integrated as a functional module at the front end (i.e., located at the input) of a video recorder. The integrated arrangement is represented by reference numeral 190 in FIG. 1 where both a video recording mechanism and a video storage and delay device of the present invention are combined within a common enclosure represented by the dashed rectangle.

The video recorder 162 is typically located in secure enclosure that may be contained in the trunk of the car. In addition, depending upon the requirements of the specific application, the video recorder 162 may also be located within the passenger compartment of the vehicle. For example, video recorder 162 may be mounted in an overhead console, under the front seat, in or under the dashboard, in the glove box, or in the electronic and emergency equipment console. Some of these mounting locations may be facilitated by the use of a video recorder that uses small form-factor videotape such as 8 mm videotape.

The enclosure containing the video recorder 162 is generally quite rugged, both to provide deterrents against tampering or improper access to the videotape, and also to protect the tape in the event that the vehicle is involved in a crash. The enclosure may also be environmentally controlled to keep the video recorder 162 and videotape within acceptable operating conditions. It is noted that video recorder 162 is merely representative of any of a number of recording devices that are arranged to record video and audio, either as a single device or a combination of devices. Such recording devices include those that record on tape as well as those that use other media, such magnetic media (including disk-drives and cartridge drives), electronic media (including volatile and non-volatile memory), and optical media (including optically writeable disks). Video recorder may thus be configured, for example, as a digital video recorder or a conventional analog VCR.

The control head 170 is located in the vehicle near the driver and is operably coupled to video recorder 162 via bus 135 and bus 155 to allow the video recorder 162 to be conveniently controlled by the officer from within the vehicle. Control head 170, in this illustrative embodiment, is arranged with typical controls such as “RECORD”, “STOP”, “REWIND”, “PLAY”, “FORWARD” and “POWER” buttons which operate the video recorder 162 accordingly. These controls are indicated by reference numerals 171, 173, 174, 176, 178 and 179, respectively, in FIG. 1.

Camera 110 may be selected from the wide variety of available cameras. Preferably, camera 110 is a compact camera (to reduce the likelihood of obstructing the officer's view out the windshield) with color capabilities such as a solid-state CCD (“charge-coupled device”) camera that can operate in low-light environments. Camera 110 may be optionally configured with digital and/or optical zoom capabilities. Camera 110, in the illustrative arrangement shown in FIG. 1, is an analog video camera with low-light color capabilities. In most applications, camera 110 is vehicle-mounted, however other camera arrangements may also be used (alone or in combination with a vehicle-mounted camera) including portable, hand held, remote, and officer-worn cameras that operate in an extra-vehicular manner.

A wireless microphone 125 is depicted in FIG. 1. Wireless microphone 125 is typically carried on the person of the officer, and thus, may be located both inside and outside of the vehicle at any given time. Wireless microphone 125 may be a conventional uni-directional (i.e., transmit-only) microphone or, as disclosed in our co-pending U.S. patent application Ser. No. 09/911,086, filed Jul. 23, 2001, be equipped with bi-directional RF communications capabilities. Wireless microphone 125 communicates with in-car video system 100 via a wireless link that is identified by reference numeral 127 in FIG. 1.

Video monitor 120 may be selected from the available pool of small and lightweight monitors, but typically comprises a color liquid crystal flat panel display (“LCD”) having an active or passive matrix display. Video monitor 120 may be mounted in the car to allow the operator to monitor either the real time video feed from the camera, or to view a previously recorded tape.

The in-car video system 100 is typically mounted in a vehicle (not shown in FIG. 1) such as a police cruiser. However, it is emphasized that the features and benefits of the present invention may be equally applicable to a wide variety of vehicle types, and further that the invention is not limited to law enforcement applications. Applications of the invention to the security and the transportation industries may be readily made, for example. Therefore, the term “officer” in the description that follows should be understood to refer to the user or operator of the inventive in-car video system in non-law enforcement applications.

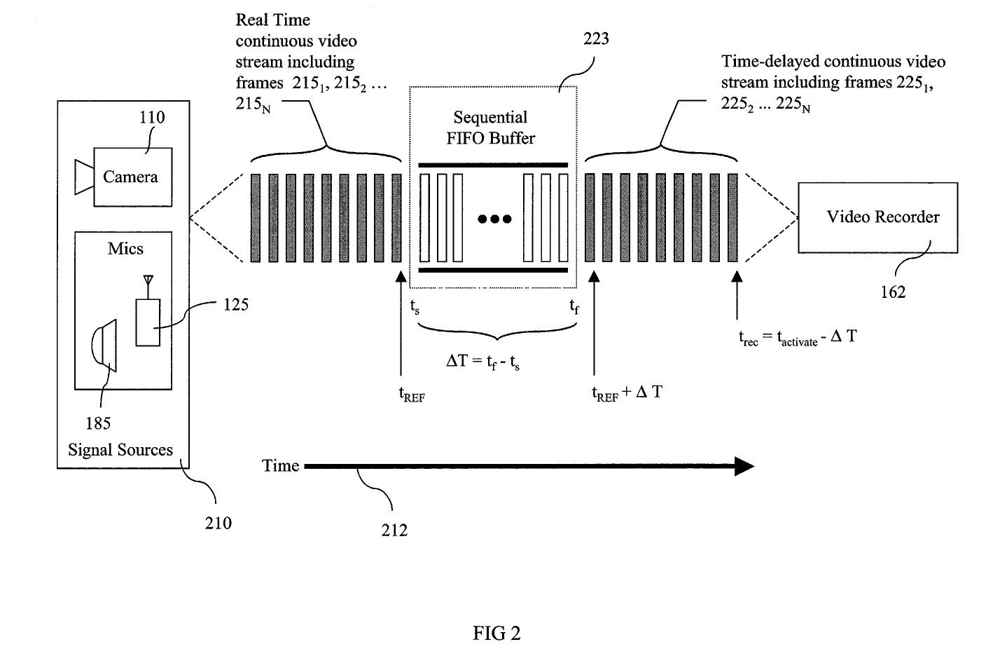

Turning now to FIG. 2, there is shown a simplified diagram of the sequential storage of the real time video stream that is used to create a time-delayed video stream, in accordance with the invention. Signal sources 210, comprising camera 110 and microphones 125 and 185 provide a real time video stream 215. Thus, video stream 215 includes three signal components—one video component and two audio components (one corresponding to each microphone 125 and 185). In this illustrative embodiment, the real time video stream 215 is in a conventional analog format.

It is noted that the term “video” as used in this detailed description means a sequence of images that is used to display full motion on equipment such as television and video monitors, along with an associated soundtrack having one or more channels. However, it is emphasized that the principles of the invention apply equally well to video or audio alone. Therefore, while the term “video” is used in this detailed description as a convenient way to describe a combined signal having a video component and one or more audio components, a combined signal is not required by the invention, nor should the use of a combined signal in this illustrative embodiment be construed as a limitation on the invention.

The term “video stream” refers to video that is continuous over some time period. The term “real time video” refers to video that corresponds to a live event (i.e., the video images of the event are created as the event occurs in actual time) but without taking into account latency and other time delays that are inherent in electronic devices.

Referring back to FIG. 2, real time video stream 215 includes video frames 1 to N that represent a NTSC (National Television Standards Committee) analog video signal having a rate of 30 frames per second, each having two interlaced fields. It is noted that the use of NTSC-defined video is merely illustrative and other formats or frame rates (e.g., PAL and SECAM) may be advantageously used in some applications of the invention. A sequential buffer 223, the function of which is incorporated in video storage and delay device 150 (FIG. 1), utilizes a First In First Out (“FIFO”) methodology to hold each frame of video for a time period ΔT:

ΔT=t_{f}−tₛ (1)

where t_{f} is defined as the time a video frame 215 is read from the buffer 223 and tₛ is the time the video frame 215 is written to the buffer. For example, as shown in FIG. 2, if frame 215₁ is written to the buffer 223 at some arbitrary reference time t=t_{REF}, then it is read out from the buffer 223 at time t=t_{REF}+ΔT. In many applications, a time-delay ΔT of between 5 and 10 seconds is a sufficient period of time for an officer to react to a witnessed event and activate the video recorder. Thus, for a five second delay, approximately 150 frames of video are buffered at any given point in time based on the standard NTSC-defined video signal used in this illustrative example.

As time progresses, each real time video frame 215 is written to the buffer 223 in time-sequential fashion. That is, each frame follows it predecessor in the real time-time video stream 215 into the buffer 223. As indicated by reference numeral 212 in FIG. 2, the video frames translate from left to right as time progresses. After being held for the time-delay period ΔT, each frame is read from the buffer 225 in a time-sequential fashion to generate a time-delayed video stream 225 that, except for the time offset ΔT from actual time, corresponds to the real time video stream 215 in sequence and content.

In accordance with the invention, the time-delayed video stream 225 may be selectively recorded by video recorder 162, as shown in FIG. 2. When the video recorder 162 is activated at time t=t_{activate}, the effective start time of the video recording, t_{rec start}, is offset by the time-delay period ΔT:

t_{rec start}=t_{activate}−ΔT (2)

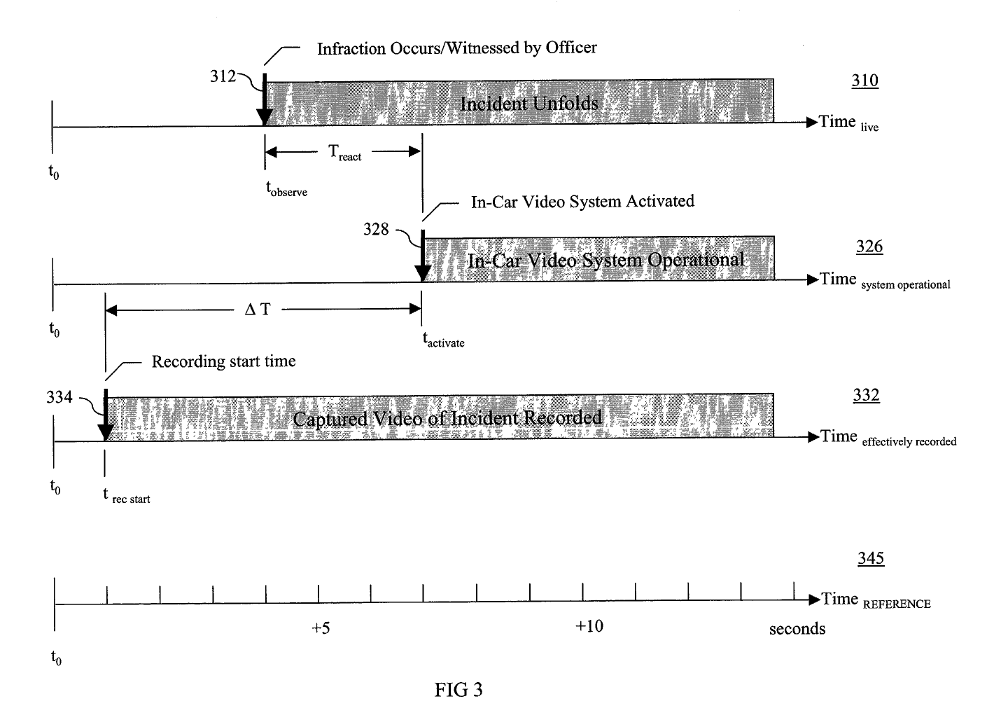

FIG. 3 depicts a group of exemplary timelines showing that the present invention provides an ability to create a permanent record of an event that begins prior to the activation of the in-car video recorder. FIG. 3 includes a live timeline 310, an in-car video system operation timeline 326, and a timeline 332 representing the effective time of recording made by video recorder 162. At the bottom of FIG. 3, a reference timeline 345 is shown. Each timeline is given an arbitrary initial time t=t₀.

Referring to timeline 310, a traffic infraction occurs that is observed by an officer on patrol in vehicle equipped with the inventive in-car video system 100. As depicted on timeline 310 at reference numeral 312 (and referring to the reference timeline 345) the infraction occurs at time t_{observe}=t₀+4 seconds. As the incident continues to unfold, after witnessing infraction and determining that a traffic stop is called for, the officer reacts and activates the emergency lights and video recorder 162 of the in-car video system so that the incident is recorded on videotape. As shown at reference numeral 328 on timeline 326 (and referring to reference timeline 345) the officer takes three seconds to make the decision to effectuate a traffic stop and activate the video recorder 162, thus t_{activate}=t₀+7 seconds. From the time t=t_{activate} onward, the in-car video system 100 is operational, as shown by timeline 326 in FIG. 3.

Referring now to timeline 332 which is the effective recording time, reference numeral 334 indicates that t_{rec start}=t₀+1 second, based on a time-delay period ΔT of six seconds in this illustrative example. From the time t=t_{rec start} onward, the video recorder 162 is making a permanent videotaped record of the incident where start time of the recording, t_{rec start}, precedes the time that the infraction is observed by the officer, t_{observe}, by three seconds, in this illustrative example.

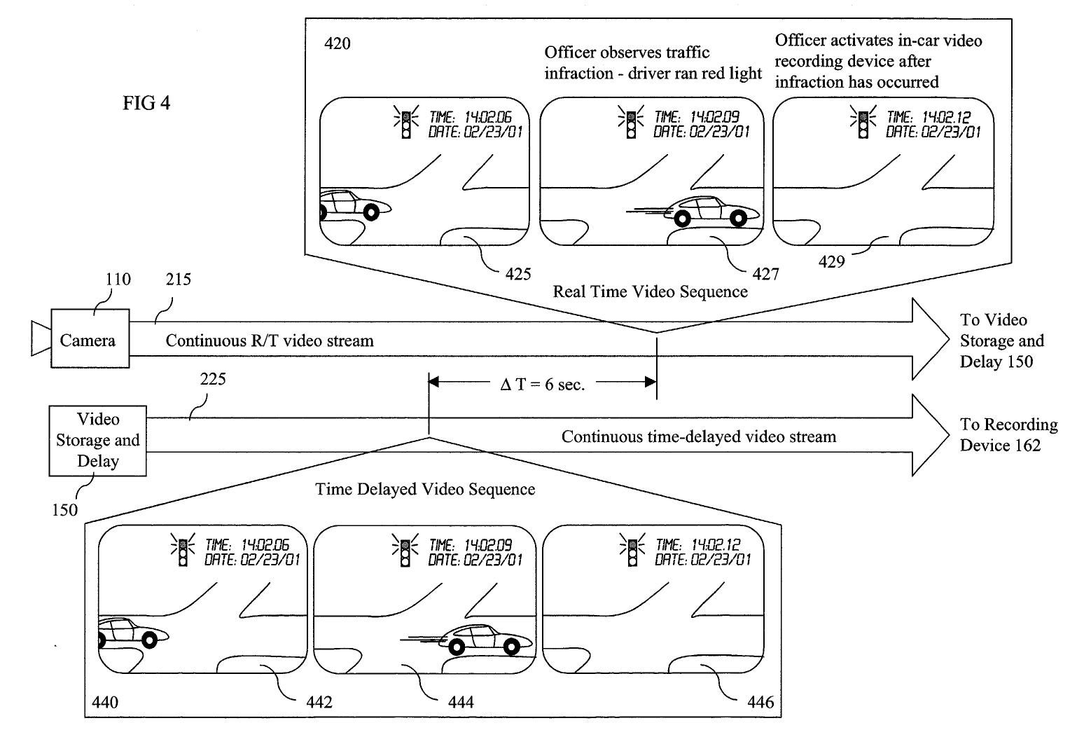

FIG. 4 shows a real time video stream, a time-delayed video stream and an exemplary video sequence, in accordance with the invention. A continuous real time video stream 215 (also shown in FIG. 2 and described in the accompanying text) is generated by camera 110 and is provided to video storage and delay device 150 via bus 135 (FIG. 1). The continuous real time video stream 215 includes an exemplary video sequence 420 including frames 425, 427, and 429, as shown in FIG. 4. As indicated by the superimposed time and date in the upper right hand comer of the video image, frames 425, 427 and 429 are several illustrative frames within a video sequence that spans a time period that starts at 14:02.06 (i.e., six seconds past 2:02 p.m.) and ends at 14:02.12 (i.e., 12 seconds past 2:02 p.m.). In frame 425, a vehicle is shown approaching a red light at an intersection. In frame 427, which depicts the scene several seconds later, the vehicle has driven through the intersection in apparent disregard of the traffic signal. In frame 429, which depicts the scene six seconds after that depicted in frame 425, the car has moved outside the field of view of the camera.

As with the example provided in the text accompanying FIG. 3, the officer determines that a car stop is called for after the infraction is witnessed at 14:02.09. Assuming a three-second reaction time as with the previous example, the officer activates the video recorder at 14:02.12, as shown in FIG. 4.

FIG. 4 also depicts a time-delayed video stream 225 (also shown in FIG. 2 and described in the accompanying text). The time-delayed video stream 225 is generated by the video storage and delay device 150 from real time video stream 215 received at its input, as described above, in accordance with the invention. The time-delayed video stream 225 includes an exemplary video sequence 440, including frames 442, 444, and 446, that is the same as video sequence 420 in sequence and content, but is offset from actual time by the time delay period ΔT.

The time-delayed video stream 225 is buffered in the video storage and delay device 150 so that it has a time delay ΔT of six seconds, as shown in FIG. 4. Accordingly, upon activation of the video recorder 162 by the officer at 14:02.12, the effective start time of the video recording, t_{rec start}, is 14:02.06 which precedes the time of the observed infraction, t_{observe}, by three seconds.

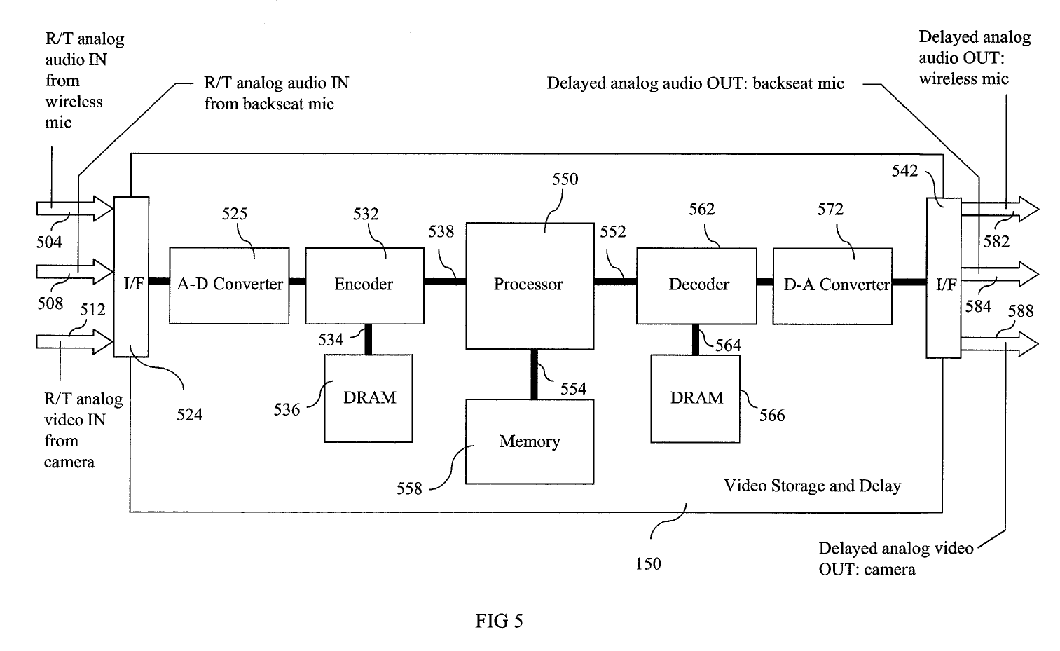

Referring now to FIG. 5, a simplified functional block diagram of an exemplary video storage and delay device 150 is shown. Video storage and delay device 150 includes an input interface 524 and an output interface 542. These I/O interfaces include signal connections for one video signal and two audio signals. In many applications, and in this exemplary embodiment, the two audio signal connections are used for audio streams associated with the wireless microphone 125 and rear seat microphone 185. The I/O interfaces 524 and 542 may also include control signal connections so that control signals from control head 170 may be passed through to the video recorder 162 that is coupled to the video storage and delay device 150 (as shown in FIG. 1 and described in the accompanying text). In addition, it may be desirable to adapt the I/O interfaces 524 or 542 with a power connection, for example, to accept +12V DC power from the vehicle. The signal connections at both the input interface 524 and the output interface 542 are realized, in this exemplary embodiment of the invention, using standard RCA-type co-axial connectors. Video and audio pass through connections (not shown in FIG. 5) may be optionally provided at the I/O interfaces 524 and 542 to implement a straight through signal path that bypasses the functions of the video storage and delay device 150.

The input interface 524 is adapted to receive real time analog signals in the exemplary embodiment of the invention depicted in FIG. 5. However, in some applications of the invention it may be desirable to accept digital signals, both digital and analog signals, or either digital or analog signals in a switchable input mode arrangement. In this exemplary embodiment, at input connection 504, a real time analog audio stream is received from the wireless microphone 125. At input connection 508, a real time analog audio stream is received from rear seat microphone 185. At input connection 512, a real time analog video stream is received from camera 110.

The following description relates to the processing of the real time video stream received at input connection 512. The processing of the two audio streams received at input connections 504 and 508 is performed in a similar (but parallel) process. The received video stream is passed from the input to an analog-to-digital converter 525 (sometime referred to as an analog decoder). The analog-to-digital converter 525 converts the NTSC-formatted analog video stream into a digitized component data stream (having color difference and luminance components, Cb, Cr and Y, respectively) that complies with the CCIR 601 digital coding standard (Consultative Committee for International Radio, also commonly referred to as the International Telecommunications Union recommendation ITU-R BT.601-5). In this exemplary embodiment of the invention, the video image has a field size of 720×243 pixels.

The output of the analog-to-digital converter 525 is fed to a digital encoder 532 as shown in FIG. 5. The digital encoder 525 takes the CCIR 601 digitized data stream and compresses the stream to reduce downstream storage and processing requirements using conventional entropy coding schemes. A dynamic random access memory (“DRAM”) device 536 is coupled to the digital encoder 525 via bus 534, as shown in FIG. 5, to provide a temporary buffer for transform and other transient data that is generated during the compression process.

Those skilled in the art will recognize that the level of compression can be chosen according to the requirements of the particular application. In some applications it may be desirable to implement low loss or loss-less compression levels, while other applications may be less sensitive to the signal degradation that typically accompanies higher compression ratios.

A central processor 550 receives the compressed digitized data stream from the encoder 532 on bus 538. The central processor 550 writes data from the received stream into a memory 558 that is coupled to the central processor 550 through bus 554. The memory 558 is preferably implemented using static RAM (“SRAM”). After data has been held in the memory 558 for a pre-set time interval, the central processor 550 reads the data out of the memory 558 and forwards the data to decoder 562 over bus 552. The central processor sequentially and continuously processes the received data stream through the memory 558 (including the steps of writing, holding and reading) and outputs a continuous compressed digitized data stream that is time-delayed compared with the received stream. Accordingly, central processor 550, in combination with memory 558, implements the FIFO buffer arrangement shown in FIG. 2 and described in the accompanying text. In addition to performing the write and read functions, the central processor 550 controls the overall signal flow and data processing throughout the video storage and delay device 150.

The decoder 562 and digital-to-analog converter 572 work in a reverse manner as encoder 532 and analog-to-digital converter 525 to restore the data stream received from the central processor 550 to substantially its original uncompressed analog form (although the stream remains time-delayed). The decoding and digital-to-analog conversion is implemented in a conventional fashion. As with the encoder 532, a DRAM device 566 is coupled through bus 564 to decoder 562 to provide a buffer for transient data that is generated during the decoding process.

The resultant time-delayed analog video stream is output on interface 542 via connections 582, 584, and 588. Connection 582 provides a time-delayed analog output stream associated with the wireless microphone 125. Connection 584 provides a time-delayed analog output stream associated with the rear seat microphone 185. Connection 588 provides a time-delayed analog video stream associated with the camera 110.

The video storage and delay device 150 may be advantageously configured as a self-contained unit which, once installed and set-up, will operate transparently in the background without requiring additional user intervention. That is, the video storage and delay device 150 needs only signal inputs and an output connection to a video recorder to create the time-delayed video stream. No modifications to the other components in the in-car video system 100 (FIG. 1) are required in order to implement the invention. The use of standard interfaces, for example the RCA co-axial connectors of the exemplary embodiment shown in FIG. 5, facilitates the use of the invention in retrofit scenarios with existing in-car video systems. In addition, very little extra training is required for an officer to be able to effectively operate the in-car video system 100 equipped with the video storage and delay device of the invention because the physical operation of the system is the same as with current in-car video systems. The officer need only be trained to understand that the selected duration of the pre-set time delay equals the amount of reaction time the officer has to activate the video recorder after witnessing an event of interest. Once this training is provided, it can be expected that officers will quickly realize the benefit provided by the invention in its ability to record an event after it has already occurred in actual time.

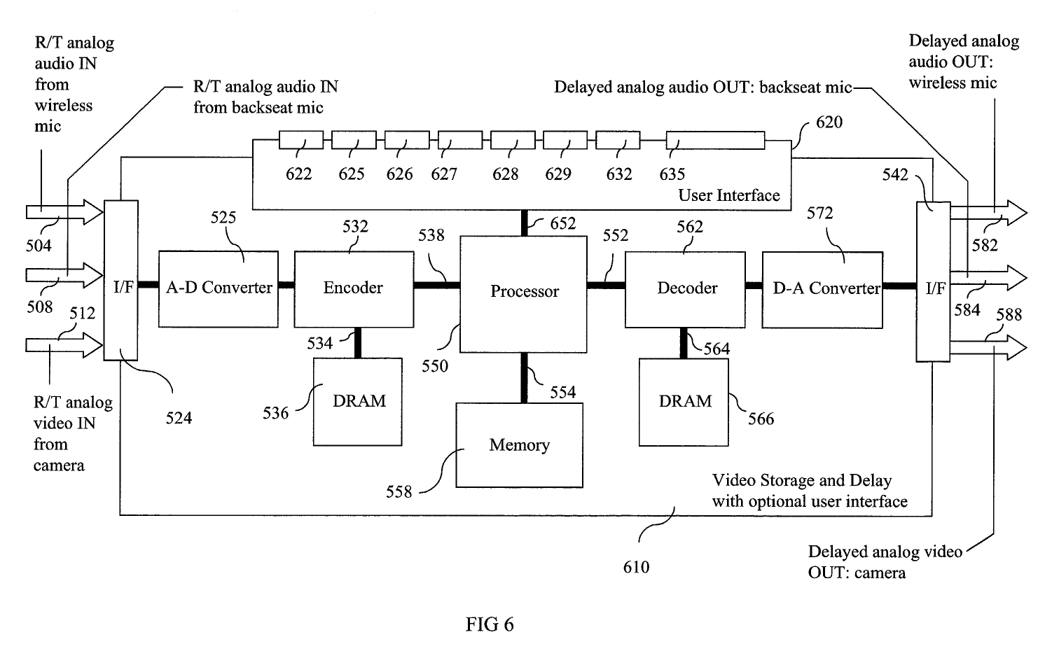

FIG. 6 a simplified functional block diagram of an exemplary video storage and delay device 610 equipped with an optional user interface 620. User interface 620 is optionally utilized in some applications of the invention to implement user-selected control of certain operating parameters of the video storage and delay device 610. The other elements shown in FIG. 6 are similar in form and operation to those depicted in FIG. 5. It is noted that the optional user interface 620 may also be utilized in embodiments of the invention where the video storage and delay device is physically integrated with a video recorder. In such a case, the user interface 620 may be used alone or in combination with other controls that may be located on the video recorder itself, or with controls that are located on the remote control head (for example, control head 170 in FIG. 1).

By interacting with the controls, the user may set-up and configure the video storage and delay device 610, in accordance with the invention. For example, in some applications it may be particularly advantageous to allow a user to define the amount of time-delay ΔT. Thus, police departments are able to fine-tune the particular amount of time-delay implemented in their in-car video systems to their specific needs or operational environment. In other applications, it may be desirable for video storage and delay device 610 to selectively supply a date and time stamp that is superimposed onto the recorded video image (as shown in exemplary video sequences 420 and 440 in FIG. 4). Video storage and delay device 610 may supply such information in those instances where other components of an in-car video system would not otherwise have the capability to record the date and time of the captured scene. Thus, video storage and delay device 610 may be retrofitted to provide the additional date/time feature upgrade to older in-car video systems.

The user interface 620 is shown in FIG. 6 as being disposed on an external surface of the video storage and delay device 610. However, in some applications of the invention, it may be desirable to arrange the user interface 620 as a module that may be located remotely from the main body of the video storage and delay device. For example, the video storage and delay device 610 may be located in the trunk of the car, while the user interface is located remotely in the passenger compartment.

User interface 620 includes a group of user-accessible controls, such as buttons, that are located on a panel 621. The controls are indicated by reference numerals 622, 625, 626, 626, 627, 628, 629, and 632, respectively, for controls “START,” “STOP,” “PLAY,” “DATE,” “UP,” DOWN,” and “SET.” The “START” and “STOP” buttons 622 and 625 turn on and off the video storage and buffering feature on the invention. In some applications of the inventions it may be desirable to arrange the video storage and delay device 610 so that it is always operational upon power up. In such a case, the “START” and “STOP” buttons 622 and 625 would be deleted from user interface 620 or otherwise made inoperative.

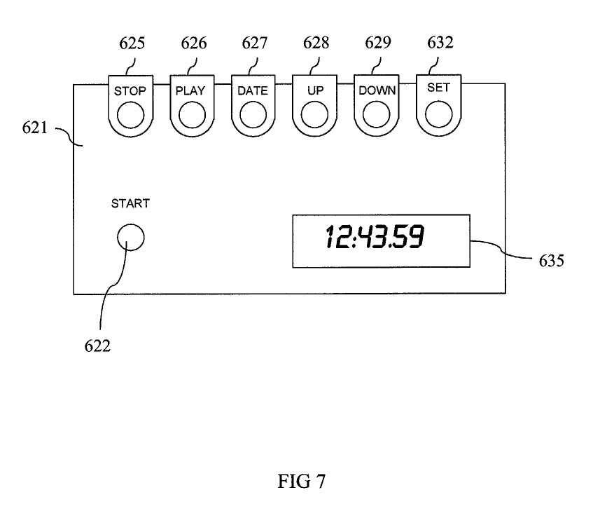

A user-viewable digital display 635, such as an LCD display, is also included in the user interface 620. FIG. 7 shows a pictorial representation of the user interface panel 621 with user-accessible controls and LCD display 635.

A user interacts with the controls on user interface 620 to set up (i.e., configure) the video storage and delay device 610. Such set up may be facilitated by the display and use of an appropriate interactive menu provided LCD display 635 in a conventional manner. For example, the menu may include selections pertaining to setting of the date and time, enabling and disabling the date/time superimposition feature, positioning the superimposed digits to a desired location on the video image (e.g., left or right, top or bottom), and setting the time delay ΔT.

The menu may be displayed on LCD display 635, for example, by pressing and holding “SET” button 632. The user may navigate through various menu selections using the “UP” and “DOWN” buttons 628 and 629 and choose a setting by pressing the “SET” button 632. To change a numerical setting, the user may position a blinking cursor (or other visual indicator) on LCD display 635 over a digit to be changed using multiple presses of the “SET” button 632. The “UP” and “DOWN” buttons 628 and 629 may be pressed accordingly to increment or decrement the digit as desired.

A user may press a button directly to set up a function as an alternative to a menu-driven set up. For example, LCD display 635 will display the last set time and date when the “DATE” button 627 is pressed. The user may change or correct the date and time by pressing and holding the “DATE” button 627. A blinking cursor is then positioned over the appropriate digit that may then be changed up or down with the “UP” and “DOWN” buttons 628 and 629.

Other features of the invention are contained in the claims that follow.

What is claimed is:

1. A method of operating a vehicle-mounted surveillance system including a camera and vehicle-mounted recording device that creates video recordings having a start time and a stop time, the method comprising the steps of:
capturing a stream of live video of an area of surveillance using the camera;
processing the live video stream to impose a delay of pre-set time interval on the live video stream to generate a time-delayed video stream; and
activating the recording device, upon an occurrence of an event at a reference time, to record the time-delayed video stream so that a video recording is created of the surveillance area and the start time of the video recording precedes the reference time by the pre-set time interval.

2. The method of claim 1 where the step of processing includes sequentially writing data representative of the live video stream into a FIFO buffer.

3. The method of claim 2 where the step of processing further includes holding the data in the FIFO buffer for the pre-set time interval.

4. The method of claim 2 where the step of processing further includes compressing the data that is written into the FIFO buffer.

5. The method of claim 3 where the time-delayed video stream is generated by reading the data out of the FIFO buffer upon expiration of the pre-set time interval.

6. The method of claim 1 where the live video stream is received as an analog-formatted stream and converted into a digitized stream.

7. The method of claim 6 where the analog-formatted stream is an NTSC-defined video stream.

8. The method of claim 1 where the live video stream is received as a digitally-formatted stream.

9. The method of claim 1 where the live video stream includes an image component and an audio component.

10. A video data storage and delay device arranged to provide a delay of a pre-set time interval to a real time video stream received from a vehicle-mounted video system, the vehicle-mounted video system including a video camera and recording device, comprising:
an input interface for receiving the real time video stream from the video camera;
a processor to process data representative of the received real time video stream and for writing the data to storage and reading the data from storage so as to create the time delay between the input and output of the video data storage and delay device;
a memory coupled to the processor to temporarily store the processed data for the pre-set time interval; and
an output interface for transmitting the delayed video signal to the recording device.

11. The video data storage and delay device of claim 10 further including a data encoder interposed between the input interface and the processor.

12. The video data storage and delay device of claim 11 wherein the data encoder compresses data in accordance with CCIR-601.

13. The video data storage and delay device of claim 10 wherein the field size associated with the data encoder is 720 pixels by 243 pixels.

14. The video data storage and delay device of claim 10 further including an analog-to-digital converter interposed between the input interface and the data encoder.

15. The video data storage and delay device of claim 10 further including a data decoder interposed between the processor and output interface.

16. The video data storage and delay device of claim 15 further including a digital-to-analog converter interposed between the the data decoder and the output interface.

17. The video data storage and delay device of claim 10 wherein the input interface and output interface include standard connections.

18. The video data storage and delay device of claim 17 wherein the connections comprise RCA-type co-axial connectors.

19. The video data storage and delay device of claim 10 wherein the processor is user-controllable to adjust processing parameters.

20. The video data storage and delay device of claim 19 wherein the processing parameters include the length of the pre-set time interval.

21. The video data storage and delay device of claim 19 further including a user interface for controlling adjustable processing parameters.

22. The video data storage and delay device of claim 21 wherein the user interface includes an interactive menu displayed on a user-viewable display.

23. The video data storage and delay device of claim 22 further including user-activated controls.

24. The video data storage and delay device of claim 10 wherein the real time video stream includes video and audio components.

25. The video data storage and delay device of claim 24 wherein the processor processes the video and audio components in separate parallel processes.

26. The video data storage and delay device of claim 24 wherein the audio component includes a first and a second audio track.

27. The video data storage and delay device of claim 26 wherein the first audio track corresponds to audio captured from a user-worn wireless microphone.

28. The video data storage and delay device of claim 10 wherein the second audio track corresponds to audio captured from a vehicle-mounted microphone.

29. The video data storage and delay device of claim 10 further including a self-contained enclosure requiring only external power and signal connections and that is adapted for retrofitting to existing in-car video installations.

30. The video data storage and delay device of claim 29 further including a signal pass-through path.

31. The video data storage and delay device of claim 10 wherein the memory is arranged from static random access memory.

32. The video data storage and delay device of claim 11 further including a first transient data buffer for temporarily storing data creating during operation of the data encoder.

33. The video data storage and delay device of claim 32 wherein the first transient data buffer is arranged from dynamic random access memory.

34. The video data storage and delay device of claim 15 further including a second transient data buffer for temporarily storing data creating during operation of the data decoder.

35. The video data storage and delay device of claim 34 wherein the second transient data buffer is arranged from dynamic random access memory.

36. The video storage and delay device of claim 10 wherein the recording device is a VCR.

37. The video storage and delay device of claim 10 wherein the recording device is a digital video recorder.

38. A method of operating a vehicle-mounted recording device, the method comprising the steps of:
capturing a stream of real time video of an area of surveillance using a video camera;
buffering the stream of real time video in a time-sequential manner for a pre-set time interval to create a buffered stream of video that is time delayed compared with the real time video stream; and
outputting the buffered and time delayed video stream to a vehicle-mounted recording device that is adapted to selectively record the buffered and time delayed video stream.

39. A method of operating a vehicle-mounted surveillance system including a camera and vehicle-mounted recording device, the method comprising the steps of:
capturing a continuous stream of real time video of an area of surveillance using the camera;
imposing a delay of pre-set time interval on the real time video stream to create a time delayed video stream; and
recording the time delayed video stream onto a storage medium using the recording device.

40. A video recorder adapted for use in a vehicle-mounted surveillance system, comprising
an input interface for receiving a real time video stream from a video source;
a processor to process data representative of the received real time video stream and for writing the data to storage and reading the data from storage so as to create a time delayed version of the real time video stream;
a memory coupled to the processor to temporarily store the processed data for the set time interval; and
a recording device for recording video and audio onto a storage medium, the recording device being coupled to the processor for receiving the time delayed version of the real time video stream.
